(19) United States
(12) Patent Application Publication
(10) Pub. No.: US 2024/0113572 A1
(43) Pub. Date: Apr. 4, 2024

(54) STEERING FEEDBACK ACTUATOR HAVING RESIDUAL FRICTION TORQUE

(71) Applicant: HL MANDO CORPORATION, Gyeonggi-do (KR)

(72) Inventor: Taesik KIM, Gyeonggi-do (KR)

(21) Appl. No.: 18/238,388

(22) Filed: Aug. 25, 2023

(30) Foreign Application Priority Data
Oct. 4, 2022 (KR) 10-2022-0126032

(51) Int. Cl. H02K 1/16; B62D 5/00; H02K 1/02; H02K 21/14

(52) U.S. Cl. CPC H02K 1/16; B62D 5/006; H02K 1/02; H02K 21/14

(57) ABSTRACT

The present disclosure provides a steering feedback actuator having residual friction torque, the steering feedback actuator including a motor configured to provide feedback torque to a steering wheel, in which the motor includes a rotor configured to be rotated by supplied power, and a stator configured to surround the rotor, in which the stator is configured by stacking a plurality of electric steel sheets that is conductors, and in which when the steering feedback actuator is broken down, an iron loss of the stator is increased by adjusting a thickness of the electric steel sheet to generate residual frictional torque for ensuring traveling stability.

### CROSS-REFERENCE TO RELATED APPLICATIONS

This application claims benefit and priority to Korean Patent Application No. 10-2022-0126032, filed on Oct. 4, 2022, with the Korean Intellectual Property Office, the disclosure of which is incorporated herein in its entirety by reference.

### TECHNICAL FIELD

The present disclosure relates to a steering feedback actuator having residual friction torque in a steering system for a vehicle, and more particularly, to a steering feedback actuator that ensures residual friction torque to prepare for a failure situation in which no feedback torque is generated from the steering feedback actuator.

### BACKGROUND

In general, a steering system for a vehicle refers to a device provided in a vehicle to enable a driver to steer the vehicle in a desired direction by manipulating a steering wheel provided in a driver seat.

Recently, electric power steering (hereinafter, referred to as ‘EPS’) devices have been widely used. The EPS device is configured such that a steering motor provides a necessary steering force under electronic control.

The EPS device operates to rotate the steering column or move a rack bar connected to the steering column by operating an EPS steering motor in accordance with steering torque applied to the steering wheel by the driver.

To this end, the EPS device includes the EPS steering motor, and a steering ECU (electronic control unit) configured to control the steering motor. A speed reducer is connected to the steering motor, and the speed reducer operates in conjunction with a steering column or the rack bar.

Meanwhile, as vehicles are changing from transportation vehicles to mobility spaces, steer-by-wire (SbW) systems, which may be applied to various vehicle platforms such as skateboards, are attracting attention as future steering devices because the steer-by-wire system may meet the needs for component commonality with a free layout.

The SbW system refers to an electrical signaled intelligent steering system that performs control by transmitting the driver's steering intention through an electrical signal without using mechanical connection between the driver steering wheel and vehicle wheels. That is, the SbW steering system steers the vehicle by using an electric motor such as a motor in a state in which mechanical connection devices, such as a steering column, a universal joint, or a pinion shaft between a steering wheel and a vehicle wheel, are eliminated.

The SbW system includes a road wheel actuator (RWA) which is an actuator that moves the vehicle wheel by transmitting the driver's steering intention to the vehicle wheel, and a steering feedback actuator (SFA) which is an actuator that provides a reaction force of the steering wheel to the driver. The SFA is also referred to as a steering reaction device.

The SbW system will be described more specifically. The SbW system generally includes a high-stage device (referred to as the SFA), a low-stage device, and a control device configured to control the high-stage device and the low-stage device.

The high-stage device (SFA) may include a torque detection part connected to the steering wheel and configured to detect torque applied to the steering wheel, and a motor configured to provide reaction torque to the steering wheel in accordance with a steering operation by means of the rack bar at the lower side.

The low-stage device generates a steering auxiliary torque signal proportional to the steering torque applied to the steering wheel and controls a steering drive motor or a steering drive actuator (RWA) that operates a pinion gear or a ball nut mechanism to move the rack bar, which is connected to a tie rod of the vehicle wheel, leftward and rightward by using the steering auxiliary torque signal.

FIG. 1 illustrates the steering feedback actuator (SFA) and a steering drive actuator (RWA). An original function of the steering feedback actuator (SFA) is to transmit a steering angle to the steering drive actuator (RWA), generate feedback torque, and provide steering stability.

However, in case that failure occurs because of various causes such as disconnection of electric wire circuits in the reaction motor of the steering feedback actuator (SFA), the feedback torque is not sufficiently generated, which causes a problem with driving stability. The feedback torque may be generated by mechanical residual friction torque, but the feedback torque is excessively low.

The vehicle may travel around a corner without problem in a normal operation condition (see FIG. 2). However, in case that the motor of the steering feedback actuator (SFA) is broken down and feedback torque is not sufficiently generated while the vehicle travels around a corner, the traveling stability is adversely affected (see FIG. 3), which causes an accident when other vehicles are present around the traveling vehicle or when the vehicle travels on a narrow road or a slippery icy road.

In case that the feedback torque generated by the operation of the reaction motor of the steering feedback actuator (SFA) is lost, suitable residual frictional torque is required to ensure traveling stability.

As a method of implementing the residual frictional torque, it is possible to increase mechanical friction by adjusting a center distance between a worm and a worm wheel of the steering system, as illustrated in FIG. 4. This method is advantageous in ensuring residual friction without a separate device, but has disadvantages of adversely affecting on-center feel, fluctuating significantly with temperature and humidity changes, and lowering friction with abrasion caused when the vehicle travels.

As another method, as illustrated in FIG. 5, it is possible to increase mechanical friction by adjusting a preload or adjusting clearance of a bearing used for the steering system. This method is advantageous in ensuring residual friction without a separate device, but has a disadvantage of adversely affecting on-center feel, fluctuating significantly with temperature and humidity changes, and causing noise when a rotary body is stabbed.

### DOCUMENT OF RELATED ART

### Patent Document

(Patent Document 1) Korean Patent Application Laid-Open No. 10-2021-0146496 (published on Dec. 6, 2021)

### SUMMARY

The present disclosure has been made in an effort to solve the above-mentioned problem in the related art, and an object of the present disclosure is to provide a steering feedback actuator that ensures residual frictional torque to prepare for a failure situation in which no feedback torque is generated.

The present disclosure has also been made in an effort to provide a steering feedback actuator that stably generates residual frictional torque without being affected by a traveling distance, temperature, humidity, and the like.

To achieve the above-mentioned objects, a steering feedback actuator having residual friction torque according to an exemplary embodiment of the present disclosure includes a motor configured to provide feedback torque to a steering wheel, in which the motor includes: a rotor configured to be rotated by supplied power; and a stator configured to surround the rotor, in which the stator is configured by stacking a plurality of electric steel sheets that is conductors, and in which when the steering feedback actuator is broken down, an iron loss of the stator is increased by adjusting a thickness of the electric steel sheet to generate residual frictional torque for ensuring traveling stability.

The thickness of the electric steel sheet may be adjusted to be larger than 0.5 mm.

The stator may be configured by stacking the plurality of electric steel sheets while insulating each of plurality of electric steel sheets with an insulator, and the iron loss of the stator may be further increased by adjusting the occupancy of the insulator in the stator in order to generate the residual frictional torque for ensuring traveling stability when the steering feedback actuator is broken down.

The iron loss may be increased by adjusting the occupancy of the insulator to less than 4%.

The iron loss may be further increased by adjusting quality of the electric steel sheet of the stator.

The stator may be configured by a low-quality stack of electric steel sheets with the iron loss of 4 W/kg or more.

The stator may be configured by a low-quality stack of electric steel sheets with the iron loss within a range of 6 to 13 W/kg.

A steering feedback actuator having residual friction torque according to another exemplary embodiment of the present disclosure includes: a motor configured to provide feedback torque to a steering wheel, in which the motor includes: a rotor configured to be rotated by supplied power; and a stator configured to surround the rotor, in which the stator is configured by a conductor, and in which when the steering feedback actuator is broken down, the stator is configured by a non-stacked rigid body to increase an iron loss of the stator to generate residual frictional torque for ensuring traveling stability.

According to the steering feedback actuator having residual friction torque according to the present disclosure configured as described above, the increase of iron losses to ensure residual friction torque in the steering feedback actuator (SFA) has an advantage of ensuring residual friction torque without using a separate device, an advantage of reducing production costs and ensuring residual friction torque stably without the influence of traveling distance, temperature, and humidity, and an advantage of increasing residual friction torque as the speed of the motor increases.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a view approximately illustrating a steering feedback actuator (SFA) and a steering drive actuator (RWA) in an SbW steering system in the related art.

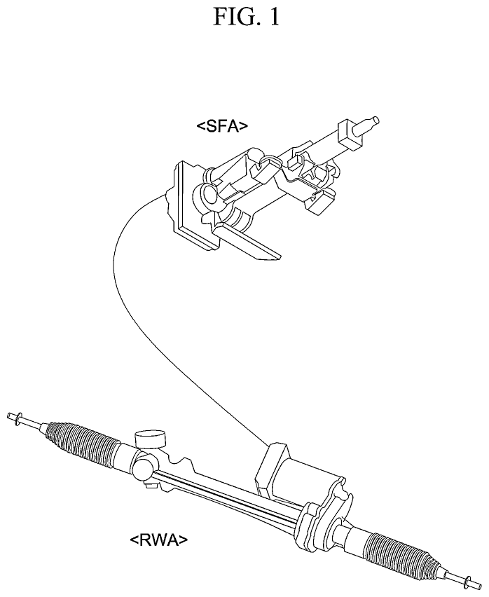

FIG. 2 is a view illustrating a situation in which a vehicle travels around a corner under a condition in which the steering feedback actuator (SFA) normally operates.

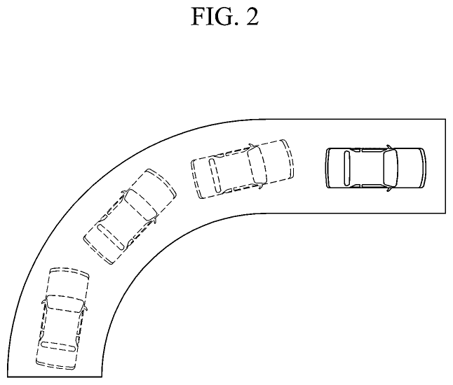

FIG. 3 is a view illustrating a situation in which a vehicle travels around a corner under a condition in which a motor of a steering feedback actuator (SFA) is broken down, and feedback torque is not sufficiently generated.

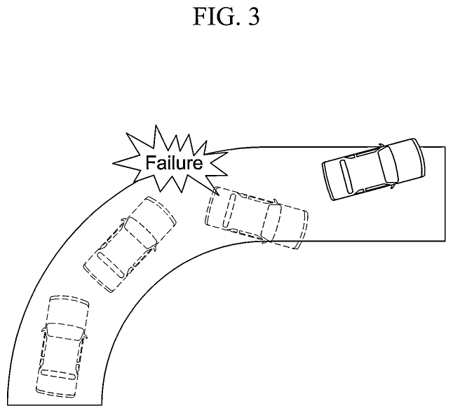

FIG. 4 is a view illustrating a worm and a worm wheel of a steering system.

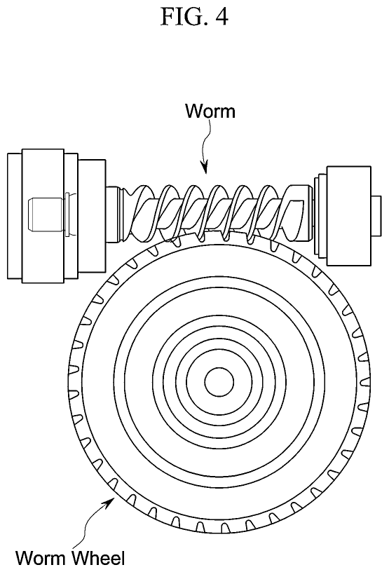

FIG. 5 is a view illustrating a bearing used for the steering system.

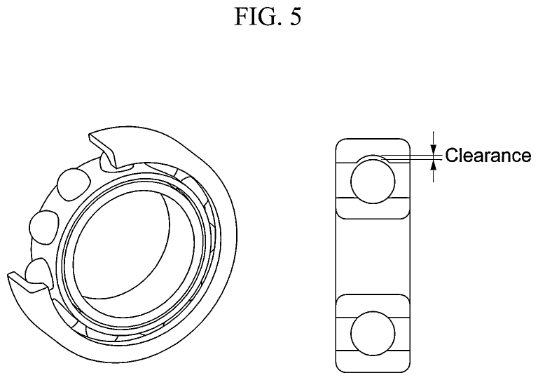

FIG. 6 is a view illustrating a structure of a motor of the steering feedback actuator (SFA).

FIG. 7 is a view illustrating hysteresis of an electric steel sheet that is a material of the motor in FIG. 6.

FIG. 8 is a view illustrating a layered structure of the motor in FIG. 6.

FIG. 9 is a view illustrating a state in which an eddy current is formed by an increase in magnetic flux in the stacked electric steel sheets, which causes an iron loss.

FIG. 10 is a view illustrating a state in which an eddy current is generated by an increase in magnetic flux in a conductive rigid body, which causes an iron loss.

FIG. 11 is a view illustrating a change in iron loss in accordance with a thickness of the electric steel sheet of the motor and an insulator content.

### DETAILED DESCRIPTION

In the following detailed description, reference is made to the accompanying drawing, which forms a part hereof. The illustrative embodiments described in the detailed description, drawing, and claims are not meant to be limiting. Other embodiments may be utilized, and other changes may be made, without departing from the spirit or scope of the subject matter presented here.

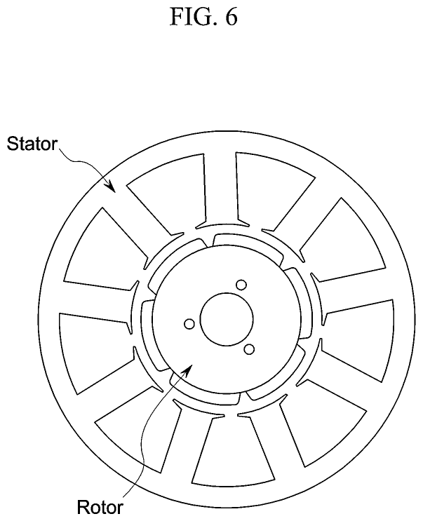

Hereinafter, a steering feedback actuator having residual friction torque according to the present disclosure will be described in detail with reference to FIGS. 6 to 11.

FIG. 6 is a view illustrating a structure of a motor of the steering feedback actuator (SFA). The motor includes a rotor configured to be rotated by supplied power, and a stator configured to surround the rotor.

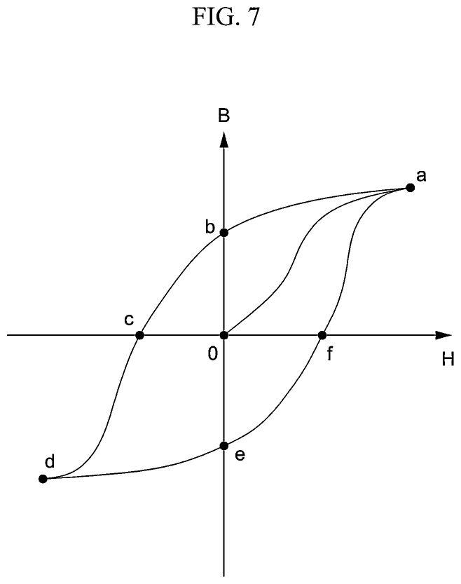

The stator of the motor is made of a conductor. The conductor exhibits a phenomenon indicated by a hysteresis curve in FIG. 7 in a magnetic field. The hysteresis curve indicates a relationship between an induced magnetic flux density B and a magnetizing force H. The hysteresis curve represents areas of loss in an alternating magnetic field. The hysteresis curve is a characteristic curve that appears when a device, such as a motor, uses alternating magnetic forces to change the direction of the magnetic force without rotating.

When the magnetic flux changes in a conductor, current flows in vortices by electromagnetic induction, and this current is called an eddy current. When the eddy current flows through a conductor plate, such as an iron or copper plate, the resistance generates heat, which causes losses in electrical devices. The use of thin plates stacked on one another with insulation between the thin plates may reduce losses due to the eddy current. The thinner the thickness (T) of the stacked plates and the higher the proportion of the insulator, the more losses due to the eddy current may be reduced.

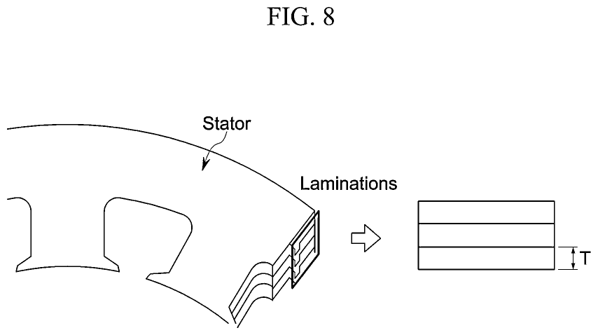

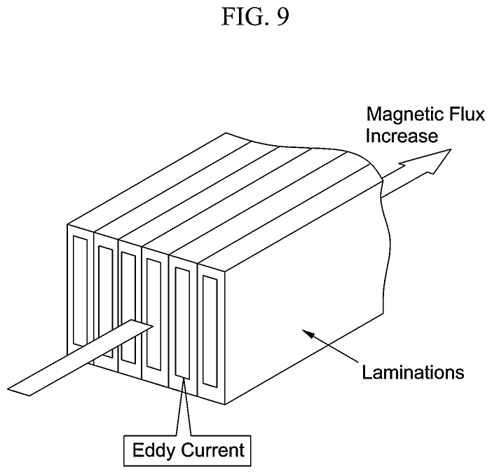

FIG. 8 illustrates a layered structure of the motor in FIG. 6. FIG. 9 illustrates a state in which a loss (referred to as an iron loss) occurs in the stacked electric steel sheet because of the eddy current in accordance with the increase in magnetic flux. As illustrated in FIGS. 8 and 9, when the stator of the motor has a layered structure of the electric steel sheets, it is possible to reduce the iron loss caused by the eddy current that occurs as the magnetic flux increases.

According to the present disclosure, in case that feedback torque is not generated by an operation of a reaction motor because of a breakdown of the steering feedback actuator (SFA), residual frictional torque for ensuring traveling stability is ensured by increasing the iron loss.

According to the embodiment of the present disclosure, in case that the stator of the motor of the steering feedback actuator (SFA) is configured by stacking a plurality of electric steel sheets. The iron loss is increased by increasing the thickness (T) of the stacked electric steel sheets. The thickness of the electric steel sheet in the related art is generally 0.5 mm or less to reduce the iron loss. In the present disclosure, in order to ensure residual friction torque, the thickness of the electric steel sheet is made larger than 0.5 mm to reduce the iron loss.

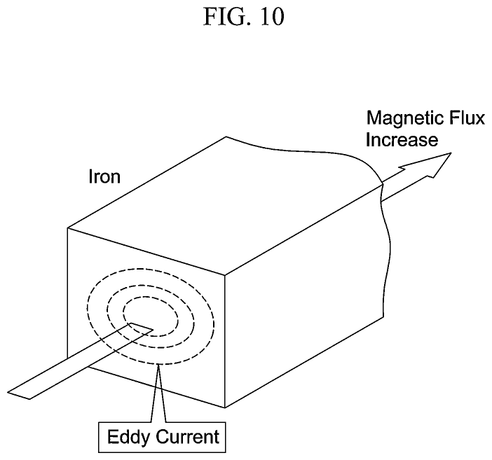

Meanwhile, as illustrated in FIG. 10, in case that a rigid body made of iron is used for the stator of the motor, the stator of the motor may be formed as a rigid body instead of a stacked structure, thereby maximizing the thickness. Motor fixtures may be formed by forging conductors such as iron to form the rigid body.

According to another embodiment of the present disclosure, adjustments are made to reduce the occupancy of the insulator to increase the iron loss to ensure residual friction torque. In the related art, thin electric steel sheets are insulated and stacked on one another to reduce iron losses. However, in the present disclosure, the occupancy of the insulator is reduced by reducing the thickness of the insulator to increase iron losses.

When a plurality of electric steel sheets is stacked, the proportion of the stack height occupied by the electric steel sheets is defined as a space factor. There is a relationship in which 100% is made by summing up the space factor of the electric steel sheets and the occupancy of the insulator. Thus, in the case of a motor fixture including an electric steel sheet and an insulator, the occupancy of the insulator may be represented by the space factor of the electric steel sheet. That is, the reduction in occupancy of the insulator for increasing the iron loss increases the space factor of the electric steel sheet.

Typically, the space factor of the electric steel sheet in the related art is about 96%. However, in the present disclosure, the iron loss is increased by adjusting the space factor of the electric steel sheet to more than 96% in order to ensure residual frictional torque. In other words, the iron loss is increased by adjusting the occupancy of the insulator to less than 4%.

By maximizing the space factor of the electric steel sheet to 100%, it is possible to maximize the iron loss by using only the electric steel sheet without using an insulator.

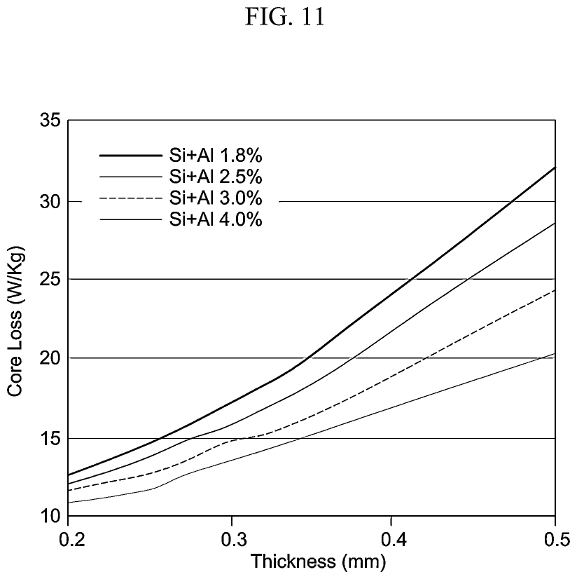

FIG. 11 is a graph illustrating the iron loss in accordance with the thickness of the stacked electric steel sheets and the occupancy of the insulator made of Si and Al for the electric steel sheet W10/400 model. As can be seen from this graph, the greater the thickness of the electric steel sheet and the smaller the occupancy of the insulator (the greater the space factor of the electric steel sheet), the greater the iron loss.

According to another embodiment of the present disclosure, the quality of the stack of the electric steel sheets is adjusted to low quality to increase the iron loss to ensure residual friction torque. The electric steel sheet in the related art uses the stack with the iron loss of 2.5 to 3.5 W/Kg. In the present disclosure, the low-quality stack of the electric steel sheets with the iron loss of 4 W/kg or more is applied. Preferably, a low-quality stack of electric steel sheets with the iron loss in the range of 6 to 13 W/kg is used.

As described above, in the present disclosure, as a method of increasing the iron loss to ensure residual frictional torque in the steering feedback actuator (SFA), it is possible to increase the thickness of the electric steel sheet stacked in the motor fixture having the layered structure of the electric steel sheets, reduce the occupancy of the insulator, or apply the low-quality stack of the electric steel sheets.

It is possible to apply any one of the three methods above, but it is also possible to apply two methods simultaneously or all three to increase the efficiency in obtaining residual friction torque.

As described above, the increase of iron losses to ensure residual friction torque in the steering feedback actuator (SFA) has an advantage of ensuring residual friction torque without using a separate device, an advantage of reducing production costs and ensuring residual friction torque stably without the influence of traveling distance, temperature, and humidity, and an advantage of increasing residual friction torque as the speed of the motor increases.

The above description is simply given for illustratively describing the technical spirit of the present disclosure, and those skilled in the art to which the present disclosure pertains will appreciate that various modifications, changes, and substitutions are possible without departing from the essential characteristic of the present disclosure. Therefore, the present embodiments are provided for illustrative purposes only but not intended to limit the technical concept of the present disclosure. The scope of the technical spirit of the present disclosure is not limited thereby. The protective scope of the present disclosure should be construed based on the following claims, and all the technical spirit in the equivalent scope thereto should be construed as falling within the scope of the present disclosure.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. A steering feedback actuator having residual friction torque, the steering feedback actuator comprising:
a motor configured to provide feedback torque to a steering wheel,
wherein the motor comprises:
a rotor configured to be rotated by supplied power; and
a stator configured to surround the rotor,
wherein the stator is configured by stacking a plurality of electric steel sheets that is conductors, and
wherein when the steering feedback actuator is broken down, an iron loss of the stator is increased by adjusting a thickness of the electric steel sheet to generate residual frictional torque for ensuring traveling stability.

2. The steering feedback actuator of claim 1, wherein the thickness of the electric steel sheet is adjusted to be larger than 0.5 mm.

3. The steering feedback actuator of claim 1, wherein the stator is configured by stacking the plurality of electric steel sheets while insulating each of plurality of electric steel sheets with an insulator, and
wherein the iron loss of the stator is further increased by adjusting the occupancy of the insulator in the stator in order to generate the residual frictional torque for ensuring traveling stability when the steering feedback actuator is broken down.

4. The steering feedback actuator of claim 3, wherein the iron loss is increased by adjusting the occupancy of the insulator to less than 4%.

5. The steering feedback actuator of claim 4, wherein the iron loss is further increased by adjusting quality of the electric steel sheet of the stator.

6. The steering feedback actuator of claim 5, wherein the stator is configured by a low-quality stack of electric steel sheets with the iron loss of 4 W/kg or more.

7. The steering feedback actuator of claim 6, wherein the stator is configured by a low-quality stack of electric steel sheets with the iron loss within a range of 6 to 13 W/kg.

8. A steering feedback actuator having residual friction torque, the steering feedback actuator comprising:
a motor configured to provide feedback torque to a steering wheel,
wherein the motor comprises:
a rotor configured to be rotated by supplied power; and
a stator configured to surround the rotor,
wherein the stator is configured by stacking a plurality of electric steel sheets, which is conductors, while insulating each of the plurality of electric steel sheets with an insulator, and
wherein when the steering feedback actuator is broken down, an iron loss of the stator is increased by adjusting the occupancy of the insulator in the stator to generate residual frictional torque for ensuring traveling stability.

9. The steering feedback actuator of claim 8, wherein the iron loss is increased by adjusting the occupancy of the insulator to less than 4%.

10. The steering feedback actuator of claim 9, wherein the iron loss is further increased by adjusting quality of the electric steel sheet of the stator.

11. The steering feedback actuator of claim 10, wherein the stator is configured by a low-quality stack of electric steel sheets with the iron loss of 4 W/kg or more.

12. The steering feedback actuator of claim 11, wherein the stator is configured by a low-quality stack of electric steel sheets with the iron loss within a range of 6 to 13 W/kg.

13. A steering feedback actuator having residual friction torque, the steering feedback actuator comprising:
a motor configured to provide feedback torque to a steering wheel,
wherein the motor comprises:
a rotor configured to be rotated by supplied power; and
a stator configured to surround the rotor,
wherein the stator is configured by stacking a plurality of electric steel sheets that is conductors, and
wherein when the steering feedback actuator is broken down, an iron loss of the stator is increased by adjusting quality of the electric steel sheet of the stator to generate residual frictional torque for ensuring traveling stability.

14. The steering feedback actuator of claim 13, wherein the stator is configured by a low-quality stack of electric steel sheets with the iron loss of 4 W/kg or more.

15. The steering feedback actuator of claim 14, wherein the stator is configured by a low-quality stack of electric steel sheets with the iron loss within a range of 6 to 13 W/kg.

16. The steering feedback actuator of claim 15, wherein the iron loss of the stator is further increased by adjusting a thickness of the electric steel sheet to generate residual frictional torque for ensuring traveling stability when the steering feedback actuator is broken down.

17. The steering feedback actuator of claim 16, wherein the thickness of the electric steel sheet is adjusted to be larger than 0.5 mm.

18. A steering feedback actuator having residual friction torque, the steering feedback actuator comprising:
a motor configured to provide feedback torque to a steering wheel,
wherein the motor comprises:
a rotor configured to be rotated by supplied power; and
a stator configured to surround the rotor,
wherein the stator is configured by a conductor, and
wherein when the steering feedback actuator is broken down, the stator is configured by a non-stacked rigid body to increase an iron loss of the stator to generate residual frictional torque for ensuring traveling stability.

19. The steering feedback actuator of claim 18, wherein the iron loss is further increased by adjusting quality of the rigid body.

20. The steering feedback actuator of claim 19, wherein the rigid body is configured by a low-quality stack of electric steel sheets with the iron loss within a range of 6 to 13 W/kg.
